(19) United States
(12) Patent Application Publication
(10) Pub. No.: US 2024/0348204 A1
(43) Pub. Date: Oct. 17, 2024

(54) INFORMATION PROCESSING METHOD FOR SOLAR POWER GENERATION COMPENSATION AND SOLAR POWER GENERATION SYSTEM

(71) Applicant: WITHUS INC., Wesley Chapel, FL (US)

(72) Inventors: Myoung Sup Oh, Wesley Chapel, FL (US); Mark Wong, Penang (MY)

(21) Appl. No.: 18/301,830

(22) Filed: Apr. 17, 2023

(51) Int. Cl. G06Q 30/0207; G01W 1/12; H02S 50/00

(52) U.S. Cl. CPC H02S 50/00; G01W 1/12; G06Q 50/06

(57) ABSTRACT

Proposed is an information processing method executed by a client terminal connected to a server through a communication network. The information processing method may include determining a load profile based on a recovery response for each of one or more plurality of photovoltaic cells included in a solar power generator. The method may also include generating a power profile of the solar power generator based on the load profile, and transmitting location information of the solar power generator and the power profile to the server. The method may further include receiving a reward based on a result of a verification for the power profile, the verification being performed by the server using the location information and meteorological observation data when the server receives the power profile.

### BACKGROUND

### Technical Field

The present disclosure relates to an information processing method for compensation for solar power generation and a solar power generation system.

### Description of Related Technology

Recently, according to fossil fuels being in danger of running out, the use of renewable energy is increasing to replace energy generation using fossil fuels, resulting in a reduction of carbon dioxide emissions. One of these renewable energy sources is solar power generation.

One of the exemplary solar power generation system includes a home solar electric system. Another solar power generation system represents a solar system including a number of photovoltaic cells of solar power generators residing in plural local regions, respectively and a server of an electricity company or the like that collects electrical energy generated by the photovoltaic cells placed in the solar power generators. The server provides and sells electrical energy to a large number of consumers.

### SUMMARY

The present disclosure provides an information processing method of a client terminal which provides a power profile corresponding to power generation of solar power generator to a server together with location information to allow the server to verify it, and gives reward to the solar power generator based on the verification result.

In addition, the present disclosure provides an information processing method of the server which after verifying a power profile of solar power generator using location information and meteorological observation data, determines and processes compensation according to the verification result.

Further, the present disclosure provides a solar power generation system including a client terminal that generates a power profile of solar power generator, and a server that determines and processes compensation after verifying the power profile.

However, the objects of the present disclosure are not limited to those mentioned above and may include another object which is not mentioned above but may be clearly understood from the following description by a person who has an ordinary knowledge in the art to which the present disclosure belongs.

In accordance with a first aspect of the present disclosure, there is provided an information processing method to be executed by a client terminal which is configured to be connected to a server through a communication network, the information processing method including: determining a load profile based on a recovery response for each of one or more plurality of photovoltaic cells included in a solar power generator; generating a power profile of the solar power generator based on the load profile; transmitting location information of the solar power generator and the power profile to the server; and receiving a reward based on a result of a verification for the power profile, the verification being performed by the server using the location information and meteorological observation data when the server receives the power profile.

In accordance with a second aspect of the present disclosure, there is provided an information processing method to be performed by a server, including: obtaining location information of a solar power generator and a power profile of power generated by the solar power generator during a predetermined period; verifying the power profile using the location information and meteorological observation data; determining a reward according to a total amount of power calculated from the power profile upon a result of the verification; and processing the reward to be provided to the solar power generator.

In accordance with a third aspect of the present disclosure, there is provided a solar power generation system including: a client terminal for generating a power profile of a solar power generator including one or more photovoltaic cells; and a server configured to verify the power profile using location information of the solar power generator and meteorological observation data, and process a reward to be provided to the solar power generator based on a result of the verification.

According to the embodiment of the present disclosure, after verifying the power profile corresponding to the power generation of the solar power generator using location information and meteorological observation data, compensation is determined and processed according to the verification result. For example, a correlation between the solar power generator and the power profile can be verified based on a result of comparing the amount of sunshine corresponding to the weather data at the solar power generation location and the power profile. Alternatively, the correlation between the solar power generator and the power profile can be verified based on a result of comparing the power profile with the sunshine time and the sunset time included in the solar observation data.

Furthermore, for the power profile whose correlation has been verified, a process of providing a reward, such as a carbon credit cryptocurrency, or the like, to the address of the blockchain user's wallet can be performed.

### BRIEF DESCRIPTION OF THE DRAWINGS

FIG. 1 shows a block diagram of a solar power generation system in accordance with one embodiment of the present disclosure.

FIG. 2 represents a block diagram of a client terminal of the solar power generation system in accordance with the embodiment of the present disclosure.

FIG. 3 depicts a block diagram of a solar power generation server of the solar power generation system in accordance with the embodiment of the present disclosure.

FIG. 4 illustrates a flowchart describing a power profile transmission process performed by the client terminal.

FIG. 5 illustrates a flowchart describing a power profile verification process performed by the solar power generation server.

FIG. 6 represents an exemplary current-voltage characteristic graph that is used when the client terminal determines a load profile.

FIG. 7 represents a graph of an exemplary power profile which shows an amount of power changes with time.

### DETAILED DESCRIPTION

The solar power generation system transmits information on the total amount of generated electrical energy when each solar power generator transmits the generated electrical energy to the server, and the server provides reward to the each solar power generator in response to the total amount of electrical energy which the each solar power generator has generated.

However, it is difficult to verify whether the information on the total amount of electric energy generated by each solar power generator is accurate data, and accordingly, the reasonable compensation procedure could not be guaranteed.

It may be possible to check the total amount of power generation for each solar power generator constituting the solar power generation system in an offline manner. However, when local solar power generator is located in a remote location far from a central server or a data collecting person, it takes a lot of time and cost to check the total amount of power generation offline.

Advantages and features of the present disclosure, and a method of achieving them will become apparent with reference to an embodiment described later together with the accompanying drawings. However, the present disclosure is not limited to an embodiment disclosed below, but may be implemented in a variety of different forms. That is, the embodiment is provided to ensure that descriptions of the present disclosure are complete and to fully inform a scope of the invention to a person with ordinary knowledge in a technical field to which the present disclosure belongs, and the invention is only defined by the scope of claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components such as software components, object-oriented software components, class components, and task components, processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

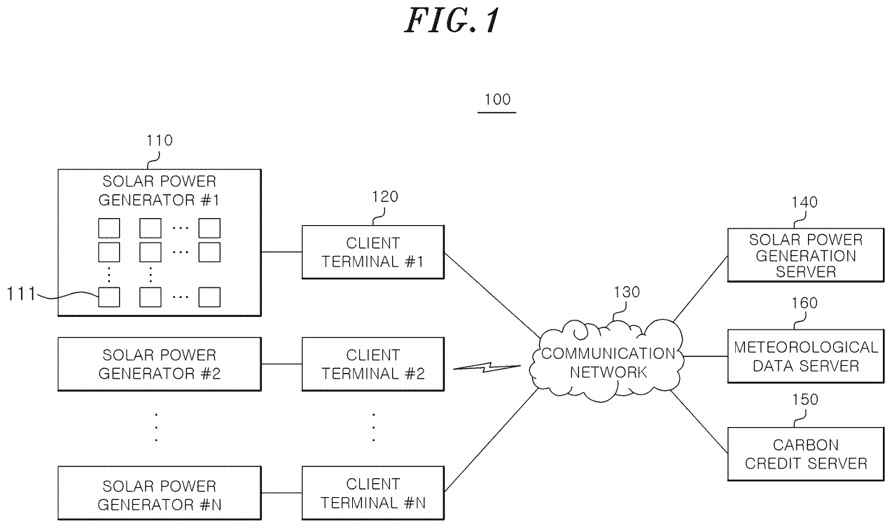

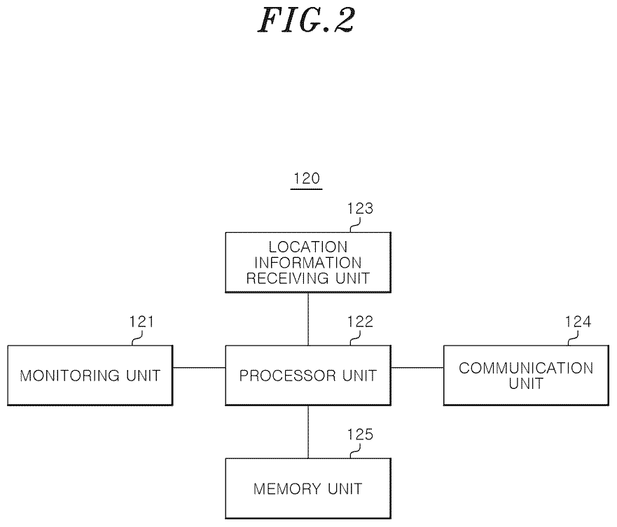

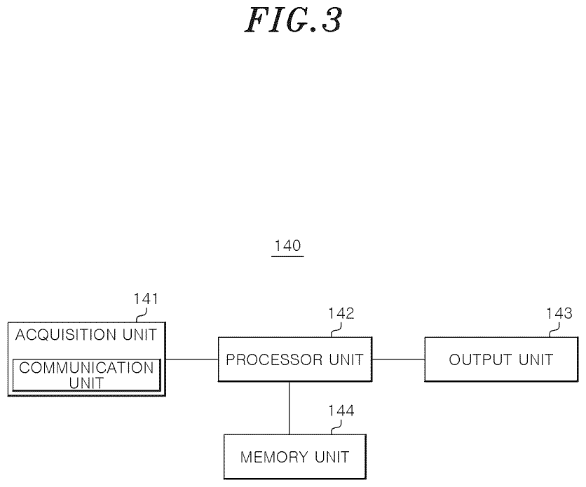

FIG. 1 is a block diagram of a solar power generation system according to one embodiment of the present disclosure, FIG. 2 is a configuration diagram of a client terminal according to one embodiment of the present disclosure, and FIG. 3 is a configuration diagram of a solar power generation server according to one embodiment of the present disclosure.

Referring to FIGS. 1 to 3, in a solar power generation system 100 according to one embodiment, a plurality of client terminals 120 corresponding one-to-one to a plurality of solar power generator 110 are connected to a solar power generation server 140 through a communication network 130. In addition, a carbon credit server 150 and/or a meteorological data server 160 may be further connected to the communication network 130.

The client terminal 120 includes a monitoring unit 121, a processor unit 122, and a communication unit 124. In addition, the client terminal 120 may further include a location information receiving unit 123 and/or a memory unit 125. In this case, a computer program including at least one instruction for enabling the processor unit 122 to process information together with the solar power generation server 140 may be stored in the memory unit 125.

The solar power generation server 140 includes an acquisition unit 141 and a processor unit 142. In addition, the solar power generation server 140 may further include an output unit 143 and/or a memory unit 144. In this case, a computer program including at least one instruction for enabling the processor unit 142 to process information together with the client terminal 120 may be stored in the memory unit 144.

The solar power generator 110 includes at least one photovoltaic cell 111 and may transmit electrical energy generated by the photovoltaic cell 111 to a solar power generation server such as an electricity company. For example, the solar power generator 110 may include various facilities like well-known solar power generator. For example, various facilities may include a solar string connection box, an inverter, a transformer, and the like.

The client terminal 120 may correspond one-to-one to the solar power generator 110, and the monitoring unit 121 may monitor charge/discharge of each photovoltaic cell 111 included in the solar power generator 110. The communication unit 124 may communicate with the solar power generation server 140 according to the control of the processor unit 122 based on the monitoring result.

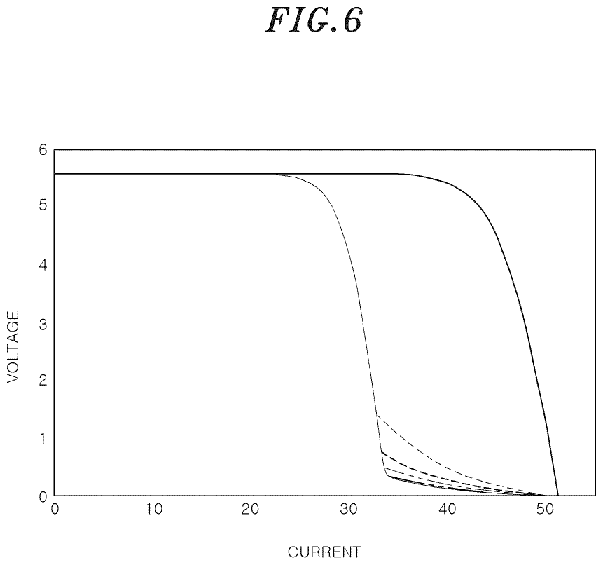

The processor unit 122 of the client terminal 120 determines a load profile based on a recovery response according to charging and discharging of each photovoltaic cell 111 included in the solar power generator 110. The determination of the load profile may be repeatedly executed and a repetition cycle of determination of the load profile may be adjusted or maintained by the number of photovoltaic cells 111 of the solar power generator 110 and the charge/discharge cycle of each photovoltaic cell 111. For example, the load profile may be determined by one current-voltage characteristic graph selected among a plurality of predetermined current-voltage characteristic graphs based on the recovery response as illustrated in FIG. 6. Further, the determined load profile and the time at which the load profile has been determined may be continuously stored in the memory unit 125.

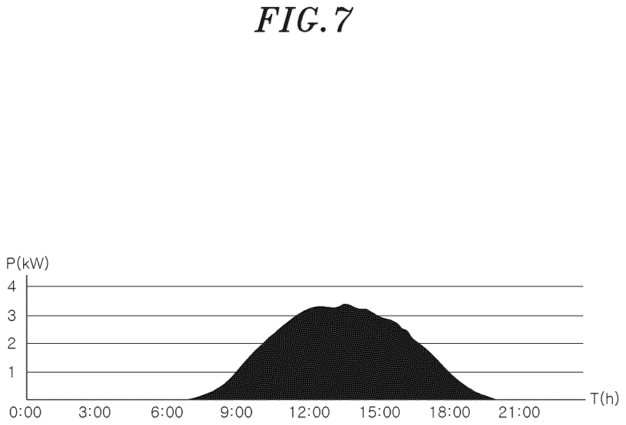

Then, the processor unit 122 of the client terminal 120 generates a power profile of the solar power generator 110 based on the determined load profile. Further, the power profile may be generated based on the determined load profile and the time at which the load profile has been determined. As shown in FIG. 7, the power profile may be generated on a daily basis, for example, and may be represented by a graph of generated power with respect to time.

The location information receiving unit 123 of the client terminal 120 receives the location information of the solar power generator 110 and provides it to the processor unit 122. For example, the location information may be global positioning system (GPS) data.

The processor unit 122 of the client terminal 120 controls the communication unit 124 to transmit the location information and power profile of the solar power generator 110 to the solar power generation server 140. Further, a transmission period for transmitting the location information and power profile of the solar power generator 110 to the solar power generation server 140 may be once a day, and may be transmitted whenever the power profile is generated. In this case, the client terminal 120 may transmit a blockchain user wallet address corresponding to the solar power generator 110 to the solar power generation server 140 together with the location information and/or power profile.

When the solar power server 140 receives the power profile and performs verification of the power profile using location information and meteorological observation data, the client terminal 120 gets a reward based on the verification result of the power profile performed by the solar power server 140. When the client terminal 120 transmits the blockchain user wallet address to the solar power generation server 140, the reward may be provided to the blockchain wallet address by processing of the solar power server 140. For example, the carbon credit server 150 by processing of the solar power generation server 140 may provide the carbon credit cryptocurrency to the blockchain wallet address corresponding to the solar power server 140.

The acquisition unit 141 of the solar power generation server 140 obtains a power profile for power generated by the solar power generator 110 for a certain period of time and location information of the solar power generator 110, and provides the obtained location information and power profile to the processor unit 142. In this case, the acquisition unit 141 may include a communication unit capable of receiving location information and power profile from the client terminal 120.

The processor unit 142 of the solar power generation server 140 verifies the power profile of the solar power generator 110 using meteorological observation data provided from the weather data server 160 and the location information received from the client terminal 120. In this case, the location information may include GPS data, and weather data of a region corresponding to the GPS data among the meteorological observation data may be used for verification. For example, the processor unit 142 may verify a correlation between an amount of sunshine corresponding to the weather data and the power profile. Specifically, it may be determined whether the total amount of daily production defined by the power profile of a specific day and the amount of sunshine corresponding to the weather data of the specific day correspond to the unit of electricity production rate (electricity production amount versus amount of sunshine) of the solar power generator 110. In this case, a normal of the surface of the photovoltaic cell 111 of the solar power generator 110 may be maintained at a predetermined angle with respect to the sun, or otherwise, the solar power server 140 may receive the difference between the normal of the surface of the photovoltaic cell 111 and the hourly angle of the sun's altitude from the client terminal 120 to further use it for the correlation verification.

Alternatively, the processor unit 142 may verify a correlation with the power profile using solar observation data of a region corresponding to GPS data among the meteorological observation data. For example, a correlation between location information of the solar power generator 110 and the power profile may be verified based on a result of comparing a rising time and a falling time of the power profile with the sunshine time and sunset time included in the solar observation data.

Then, the processor unit 142 of the solar power generation server 140 determines a reward according to the total amount of power calculated from the power profile based on the verification result, and provides the determined reward to the solar power generator 110. When the acquisition unit 141 obtains the blockchain wallet address corresponding to the solar power generator 110 and provides it to the processor unit 142, the processor unit 142 may perform a process that provides a reward to the obtained blockchain wallet address. For example, the processor unit 142 requests the carbon credit server 150 through the communication unit 124 so that the carbon credits cryptocurrency can be provided as a reward to the blockchain wallet address obtained by the acquisition unit 141.

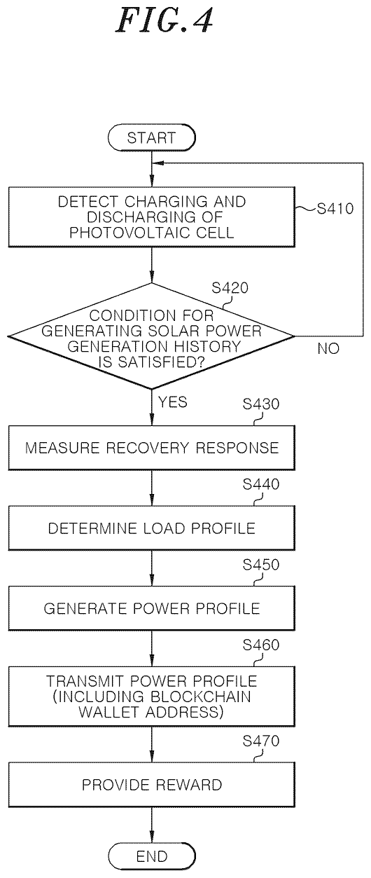

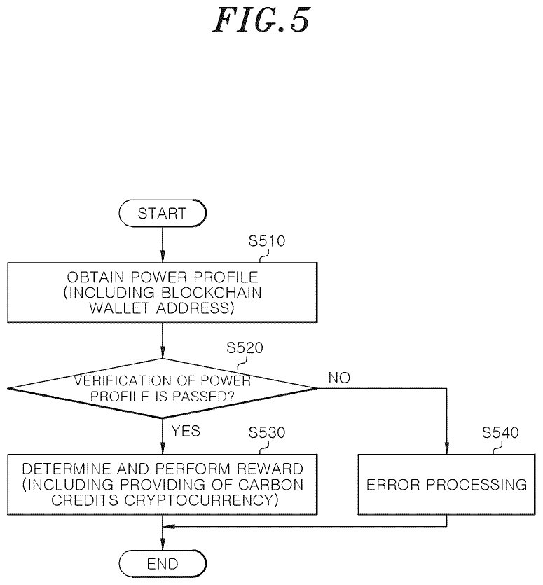

FIG. 4 is a flowchart for explaining the power profile transmission process by the client terminal according to one embodiment of the present disclosure, and FIG. 5 is a flowchart for explaining the power profile verification process by the solar power generation server according to one embodiment of the present disclosure.

Hereinafter, with reference to FIGS. 1 to 5, there will be described in detail a process in the solar power generation system according to one embodiment of the present disclosure, in which a power profile for solar power generation of solar power generator is generated at the client end and verified at the server end, and compensation according to the verification result is provided.

First, the monitoring unit 121 of the client terminal 120 performs monitoring to detect charging and discharging of each photovoltaic cell 111 included in the solar power generator 110, and the charging/discharging monitoring result for each photovoltaic cell 111 is provided to the processor unit 122 of the client terminal 120. For example, a monitoring result of a charging state corresponding to solar power generation of each photovoltaic cell 111 and a discharging state for electric power transmission after fully charged may be provided to the processor unit 122 (S410).

Then, the processor unit 122 checks the condition for generating a preset solar power generation history for the solar power generator 110 (S420), and confirms, if the condition for generating the solar power generation history is satisfied, a recovery response according to charging and discharging of each photovoltaic cell 111 included in the solar power generator 110 (S430). For example, the condition for generating the solar power generation history may be a condition corresponding to any one of a charging start time, a full charge time, a discharge start time, and a discharge completion time of the photovoltaic cell 111.

Then, the processor unit 122 determines a load profile for each photovoltaic cell 111 included in the solar power generator 110 based on the confirmed recovery response. For example, the load profile may be determined by a current-voltage characteristic graph showing different changes depending on the intensity of sunlight during charging and discharging of the solar power generator 110. In this case, the determining the load profile may be repeatedly executed and a repetition cycle in which the processor unit 122 determines the load profile may be determined by the number of the photovoltaic cells 111 of the solar power generator 110 and the charge/discharge cycle of each photovoltaic cell 111. For example, the load profile may be determined for each photovoltaic cell 111 included in the solar power generator 110 whenever the corresponding photovoltaic cell 111 is charged and discharged. Accordingly, the load profile determined by the processor unit 122 may include a current-voltage characteristic graph selected from among a plurality of current-voltage characteristic graphs based on the recovery response. For example, the load profile including a current-voltage characteristic graph selected from among the plurality of current-voltage characteristic graphs based on the recovery response as illustrated in FIG. 6 may be determined (S440).

Then, the processor unit 122 of the client terminal 120 generates a power profile of the solar power generator 110 based on the determined load profile. In this case, the processor unit 122 may generate a power profile corresponding to the total amount of power generated by the solar power generator 110. For example, the processor unit 122 may collect all of the load profiles determined for the respective photovoltaic cell 111 included in the solar power generator 110 and generate a power profile corresponding to the total amount of power generated by the solar power generator 110. For example, the power profile may be generated on a daily basis, and may be represented by a graph of generated power with respect to time (S450).

Before, during, or after the generation of the power profile by the processor unit 122 as described above, the location information receiving unit 123 of the client terminal 120 receives location information of the solar power generator 110 and provides it to the processor unit 122. For example, the location information may be GPS data.

Then, the processor unit 122 of the client terminal 120 controls the communication unit 124 to transmit the location information and the power profile of the solar power generator 110 to the solar power generation server 140. In this case, the client terminal 120 may transmit a blockchain wallet address corresponding to the solar power generator 110 to the solar power generation server 140 together with location information and/or the power profile (S460).

Next, the acquisition unit 141 of the solar power generation server 140 obtains the power profile for power generated by the solar power generator 110 for a certain period of time and the location information of the solar power generator 110, and provides the obtained location information and power profile to the processor unit 142 of the solar power server 140. For example, the acquisition unit 141 may include a communication unit capable of receiving location information and a power profile from the client terminal 120, and receive location information and a power profile from the client terminal 120 through the communication unit. In addition, after the location information and power profile are received from the client terminal 120 by a separate communication module, they may be provided to the acquisition unit 141 through a serial interface or the like. In this case, the acquisition unit 141 may obtain the blockchain wallet address corresponding to the solar power generator 110 and provide it to the processor unit 142 (S510).

The processor unit 142 of the solar power generation server 140 verifies the power profile of the solar power generator 110 using the meteorological observation data provided from the weather data server 160 and the location information received from the client terminal 120. In this case, the processor unit 142 may verify a correlation between meteorological observation data of a region corresponding to the received location information and a power profile. This may be checking whether the power profile obtained in step S510 has a correlation with the solar power generation environment of the solar power generator 110 that has transmitted the power profile through step S460 among the plurality of solar power generator 110.

Hereinafter, the verification process by the processor unit 142 of the solar power generation server 140 will be described in more detail. The weather data of a region corresponding to GPS data may be extracted from the meteorological observation data, the amount of sunshine corresponding to the extracted weather data may be calculated, and the verification may be passed when the total amount of power generation according to the power profile could be produced by the calculated amount of sunshine. Specifically, it may be determined whether the total amount of daily production defined by the power profile of a specific day and the amount of sunshine corresponding to the weather data of the specific day correspond to the unit of electricity production rate (electricity production amount versus amount of sunshine) of the solar power generator 110. In this case, the normal of the surface of the photovoltaic cell 111 of the solar power generator 110 to the sun may be maintained at a predetermined angle, or otherwise, the solar power server 140 may receive the difference between the normal of the surface of the photovoltaic cell 111 and the hourly angle of the sun's altitude from the client terminal 120 to further use it for the correlation verification.

Alternatively, the processor unit 142 may verify a correlation with the power profile by using solar observation data of a region corresponding to GPS data among the meteorological observation data, or the processor unit 142 may verify a correlation between location information of the solar power generator 110 and the power profile based on a result of comparing a rising time and a falling time of the power profile with the sunshine time and sunset time included in the solar observation data (S520).

Then, the processor unit 142 of the solar power generation server 140 may determine a reward according to the total amount of power calculated from the power profile based on the verification result. For example, the processor unit 142 may calculate the total amount of power from the power profile obtained in step S510 when the verification passes in step S520, that is, when it is determined that there is a correlation, and may determine whether to compensate for the calculated total amount of power and the degree of compensation. In this case, when obtaining the blockchain wallet address corresponding to the solar power generator 110 in step S510, the processor unit 142 may perform processing to provide a reward to the obtained blockchain wallet address. For example, the processor unit 142 may perform processing to request the carbon credit server 150 through the communication unit 124 so that the carbon credits cryptocurrency can be provided as a reward to the blockchain wallet address obtained by the acquisition unit 141 (S530).

Alternatively, the processor unit 142 of the solar power generation server 140 may perform error processing according to the verification result. For example, when the verification does not pass in step S520, that is, when it is determined that there is no correlation, the processor unit 142 may discard the corresponding data without processing compensation for the power profile obtained in step S510 (S540).

In step S530, when the reward is determined and processed by the processor unit 142 of the solar power generation server 140, the corresponding solar power generator 110 receives the reward corresponding to the power profile generated in step S450 (S470).

Meanwhile, a computer program may be implemented to include instructions for causing a processor to perform each step included in the information processing method according to the above-described embodiment.

In addition, the computer program including instructions for causing the processor to perform each step included in the information processing method according to the above-described embodiment may be recorded on a computer-readable storage medium.

As described above, according to the embodiment of the present disclosure, after verifying the power profile corresponding to the power generation of the solar power generator using location information and meteorological observation data, the reward is determined and processed according to the verification result. For example, a correlation between the solar power generator and the power profile may be verified based on a result of comparing the power profile and the amount of sunshine corresponding to the weather data of the solar power generation location. Alternatively, the correlation between the solar power generator and the power profile may be verified based on a result of comparing the power profile with the sunshine time and the sunset time included in the solar observation data.

Furthermore, for the power profile whose correlation has been verified, a process of providing a reward, such as a carbon credit cryptocurrency, to the blockchain wallet address may be performed.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable recording medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

What is claimed is:

1. An information processing method to be performed by a client terminal which is configured to be connected to a server through a communication network, the information processing method comprising:
determining a load profile based on a recovery response for one or more photovoltaic cells included in a solar power generator;
generating a power profile of the solar power generator based on the load profile;
transmitting location information of the solar power generator and the power profile to the server; and
receiving a reward based on a result of a verification for the power profile, the verification being performed by the server using the location information and meteorological observation data after the server receives the power profile.

2. The information processing method of claim 1, wherein determining the load profile is repeatedly executed and a repetition cycle of the determining the load profile is determined by a number of the photovoltaic cells of the solar power generator and a charge/discharge cycle of each photovoltaic cell.

3. The information processing method of claim 1, wherein the load profile includes one current-voltage characteristic graph selected from among a plurality of predetermined current-voltage characteristic graphs based on the recovery response.

4. The information processing method of claim 1, further comprising:
transmitting a blockchain wallet address corresponding to the solar power generator to the server,
wherein the reward is provided to the blockchain user wallet address.

5. The information processing method of claim 4, wherein the reward includes a carbon credit cryptocurrency.

6. An information processing method to be performed by a server, comprising:
obtaining location information of a solar power generator and a power profile of power generated by the solar power generator during a predetermined period;
receiving meteorological observation data from an external device;
verifying the power profile using the location information and the meteorological observation data;
determining a reward according to a total amount of power calculated from the power profile upon a result of the verification; and
processing the reward to be provided to the solar power generator.

7. The information processing method of claim 6, wherein the location information includes global positioning system (GPS) data, and weather data of a region corresponding to the GPS data among the meteorological observation data is used in the verifying.

8. The information processing method of claim 7, wherein the verifying includes verifying a correlation between an amount of sunshine corresponding to the weather data and the power profile.

9. The information processing method of claim 6, wherein the location information includes global positioning system (GPS) data, and solar observation data of a region corresponding to the GPS data among the meteorological observation data is used in the verifying.

10. The information processing method of claim 9, wherein the verifying includes comparing a rising time and a falling time in the power profile with a sunshine time and a sunset time included in the solar observation data.

11. The information processing method of claim 6, further comprising:
obtaining a blockchain wallet address corresponding to the solar power generator,
wherein the processing includes providing the reward to the blockchain wallet address.

12. A solar power generation system comprising:
a client terminal configured to generate a power profile of a solar power generator including one or more photovoltaic cells; and
a server configured to verify the power profile using location information of the solar power generator and meteorological observation data, and process a reward to be provided to the solar power generator based on a result of a verification for the power profile.

13. The solar power generation system of claim 12, wherein the location information includes global positioning system (GPS) data, and wherein the server is configured to use weather data of a region corresponding to the GPS data among the meteorological observation data in the verification.

14. The solar power generation system of claim 12, wherein the location information includes global positioning system (GPS) data, and wherein the server is configured to use solar observation data of a region corresponding to the GPS data among the meteorological observation data in the verification.

15. The solar power generation system of claim 12, wherein the client terminal is configured to transmit to the server a blockchain wallet address corresponding to the solar power generator, and
wherein the server is configured to process providing the reward to the blockchain wallet address.
